(19) United States
(12) Patent Application Publication
(10) Pub. No.: US 2015/0062449 A1
(43) Pub. Date: Mar. 5, 2015

(54) TOUCH PANEL

(71) Applicant: Samsung Electro-Mechanics Co., Ltd., Suwon (KR)

(72) Inventor: Jang Ho PARK, Suwon (KR)

(73) Assignee: SAMSUNG ELECTRO-MECHANICS CO., LTD., Suwon (KR)

(21) Appl. No.: 14/072,647

(22) Filed: Nov. 5, 2013

(30) Foreign Application Priority Data
Aug. 29, 2013 (KR) 10-2013-0103192

(51) Int. Cl. G06F 3/044

(52) U.S. Cl. CPC G06F 3/044; G06F 2203/04112
USPC 349/12

(57) ABSTRACT

There is provided a touch panel including a substrate, and a plurality of electrodes formed on the substrate, wherein the plurality of electrodes may include a plurality of fine conductive lines formed in a mesh pattern, and the plurality of fine conductive lines may have different aperture ratios for a predetermined plurality of respective regions of the substrate.

### CROSS-REFERENCE TO RELATED APPLICATIONS

This application claims the benefit of Korean Patent Application No. 10-2013-0103192 filed on Aug. 29, 2013, with the Korean Intellectual Property Office, the disclosure of which is incorporated herein by reference.

### BACKGROUND

The present disclosure relates to a touch panel.

In general, a touchscreen apparatus such as a touchscreen, a touch pad, or the like, an input means attached to a display apparatus to provide an intuitive input method to a user, has recently been widely used in various electronic apparatuses such as cellular phones, personal digital assistants (PDAs), navigation apparatuses, and the like. Particularly, as demand for smartphones has recently increased, the use of a touchscreen capable of providing various input methods in a limited form factor has correspondingly increased.

Touchscreens used in portable apparatuses may mainly be divided into resistive type touchscreens and capacitive type touchscreens according to a method of sensing a touch input implemented therein. Here, the capacitive type touchscreen has advantages in that it has a relatively long lifespan and various input methods and gestures may be easily used therewith, such that the use thereof has increased. Particularly, capacitive type touchscreens may more easily allow for a multi-touch interface as compared with resistive type touchscreens, such that they are widely used in apparatuses such as smartphones, and the like.

Capacitive type touchscreens include a plurality of electrodes having a predetermined pattern and defining a plurality of nodes in which capacitance changes are generated by a touch input. In the plurality of nodes distributed on a two-dimensional plane, a self-capacitance or mutual-capacitance change is generated by the touch input. A coordinate of the touch input may be calculated by applying a weighted average method, or the like, to the capacitance change generated in the plurality of nodes.

In a touch panel according to the related art, a sensing electrode recognizing a touch is generally formed of indium tin oxide (ITO). However, ITO is relatively expensive and is not particularly competitive in terms of price, since indium used as a raw material thereof is a rare earth metal. In addition, indium reserves are expected to be depleted within the next decade, such that it may not be easily supplied. Research into technology for forming the electrode using opaque fine conductive lines for reasons mentioned above has been conducted. Here, the electrode formed of the fine conductive lines may have better conductivity than that of the ITO or conductive polymer and the supply thereof may be smoothly performed. However, in order to use fine conductive lines as the electrode for the touchscreen, transparency and invisibility need to be increased and terminal resistance needs to be suppressed.

Patent Document 1 of the following related art document discloses content of increasing an area of a sensor electrode and decreasing a distance at an edge portion in order to reinforce output coordinates of the edge portion in the capacitive type touchscreen, but this configures the electrode using the ITO, and does not disclose content of implementing the electrode using the fine conductive lines and content in which the fine conductive lines of a central region and an edge region have different aperture ratios.

### RELATED ART DOCUMENT

(Patent Document 1) Korean Patent Laid-Open Publication No. 10-2013-0044432

### SUMMARY

An aspect of the present disclosure provides a touch panel in which fine conductive lines formed in a mesh pattern may have different aperture ratios in a central region and an edge region.

According to an aspect of the present disclosure, there is provided a touch panel, including: a substrate; and a plurality of electrodes formed on the substrate, wherein the plurality of electrodes may include a plurality of fine conductive lines formed in a mesh pattern, and the plurality of fine conductive lines may have different aperture ratios for a predetermined plurality of respective regions of the substrate.

The plurality of regions may include a central region and an edge region, and the aperture ratio of the fine conductive lines in the central region may be greater than the aperture ratio of the fine conductive lines in the edge region.

The aperture ratio of the edge region may be 20% or more to below 100% of the aperture of the central region.

The aperture ratios may be determined by at least one of a pitch and a line width of the fine conductive lines.

The fine conductive lines of the edge region may have a line width above 100% to 250% or less of a line width of the fine conductive lines of the central region.

The line width of the fine conductive lines of the central region may be 0.5 μm or more to below 6 μm.

The line width of the fine conductive lines of the edge region may be 1 μm or more to below 10 μm.

The fine conductive lines of the central region may have a pitch above 100% to below 500% of a pitch of the fine conductive lines of the edge region.

The pitch of the fine conductive lines of the central region may be 20 μm or more to below 500 μm.

The pitch of the fine conductive lines of the edge region may be 40 μm or more to below 1000 μm.

The edge region may have an area of 5% or more to below 95% of an area of the central region.

The edge region may include a first edge region and a second edge region, the first edge region being a region having a predetermined area on three sides among four sides of the substrate, the second edge region being a region having a predetermined area on a side among the four sides of the substrate, and the first edge region having an aperture ratio greater than that of the second edge region.

The second edge region may be physically distant from a controller integrated circuit obtaining a sensing signal from the plurality of electrodes, as compared to the first edge region.

The plurality of fine conductive lines may be formed of one of silver (Ag), aluminium (Al), chromium (Cr), nickel (Ni), molybdenum (Mo), and copper (Cu) or an alloy containing at least two of Ag, Al, Cr, Ni, Mo, and Cu.

The substrate may be formed of at least one of polyethylene terephthalate (PET), polycarbonate (PC), polyethersulfone (PES), polyimide (PI), polymethylmethacrylate (PMMA), cyclo-olefin polymers (COP), soda glass, and tempered glass.

The aperture ratios may satisfy the following Equation for a pitch and a line width of the fine conductive lines.

$$to = {( \frac{T - d}{T} )}^{2} \qquad [ Equation ]$$

Where, to an aperture ratio, T is pitch, and d is line width.

The plurality of electrodes may include: a plurality of first electrodes extending in a first axial direction, and a plurality of second electrodes extending in a second axial direction intersecting with the first axial direction.

The plurality of first electrodes and the plurality of second electrodes may be formed on the same surface or different surfaces of the substrate.

According to another aspect of the present disclosure, there is provided a touch panel, including: a substrate; and a plurality of electrodes formed on the substrate, wherein the plurality of electrodes may include fine conductive lines formed in a mesh pattern, and the fine conductive lines may have an aperture ratio increased from an edge of the substrate towards a center thereof.

The aperture ratio of the fine conductive lines formed in a mesh pattern may be changed in a range of 10% or more to below 99%.

The fine conductive lines may have a line width changed in a range of 0.5 μm or more to below 10 μm.

The fine conductive lines may have a pitch changed in a range of 20 μm or more to below 1000 μm.

The plurality of fine conductive lines may be formed of one of Ag, Al, Cr, Ni, Mo, and Cu or an alloy containing at least two of Ag, Al, Cr, Ni, Mo, and Cu.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a perspective view showing the exterior of an electronic apparatus including a touch panel according to an embodiment of the present disclosure;

FIGS. 2 and 3 are views schematically illustrating the touch panel according to the embodiment of the present disclosure;

FIGS. 4 and 5 are views illustrating the touch panel according to the embodiment of the present disclosure in greater detail;

FIG. 6 is a partial enlarged view of fine conductive lines according to the embodiment of the present disclosure;

FIG. 7 is a view illustrating the touch panel according to the embodiment of the present disclosure; and

FIG. 8 is a view illustrating a touch panel according to another embodiment of the present disclosure.

### DETAILED DESCRIPTION

Hereinafter, embodiments of the present disclosure will be described in detail with reference to the accompanying drawings. The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art. In the drawings, the shapes and dimensions of elements may be exaggerated for clarity, and the same reference numerals will be used throughout to designate the same or like elements.

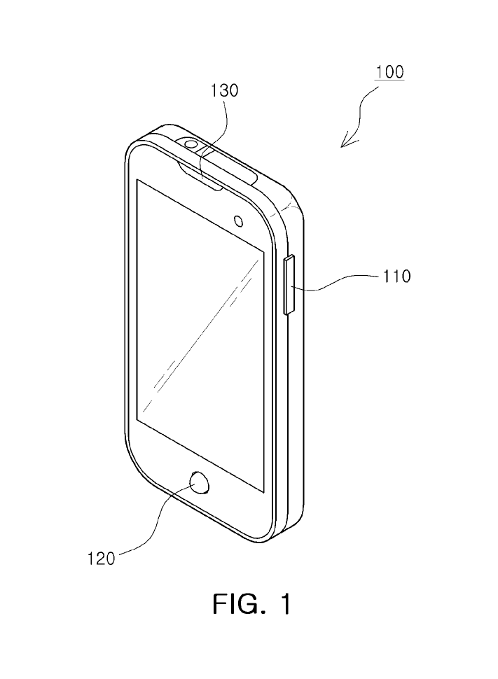

FIG. 1 is a perspective view showing the exterior of an electronic apparatus including a touch panel according to an embodiment of the present disclosure.

Referring to FIG. 1, an electronic apparatus 100 according to the present embodiment may include a display apparatus 110 for outputting a screen, an input unit 120, an audio unit 130 for audio output, and a touchscreen apparatus integrated with the display apparatus 110, wherein a touch panel may be included in the touchscreen apparatus.

As illustrated in FIG. 1, in the case of a mobile device, the touchscreen apparatus may be generally integrated with the display apparatus and needs to have a high degree of light transmissivity to which an image passes through a screen displayed on the display apparatus. Therefore, the touchscreen apparatus may be implemented by forming an electrode on a film such as polyethylene terephthalate (PET), polycarbonate (PC), polyethersulfone (PES), polyimide (PI), polymethylmethacrylate (PMMA), cyclo-olefin polymers (COP), or the like, or a transparent substrate formed of a material such as soda glass or tempered glass using a material having conductivity. A wiring pattern connected to the electrode formed of a transparent conductive material is formed in a bezel region of the display apparatus. Since the wiring pattern is visually shielded by the bezel region, the wiring pattern may also be formed of a metal such as silver (Ag), copper (Cu), or the like.

The touchscreen apparatus may be a capacitive type touchscreen apparatus and accordingly, it may include a plurality of electrodes having a predetermined pattern. Also, the touchscreen apparatus according to an embodiment of the present disclosure may include a capacitance detection circuit detecting changes in capacitance generated in the plurality of electrodes, an analog-to-digital conversion circuit converting an output signal from the capacitance detection circuit into a digital value, an operation circuit determining a touch input by using data converted as the digital value, and the like.

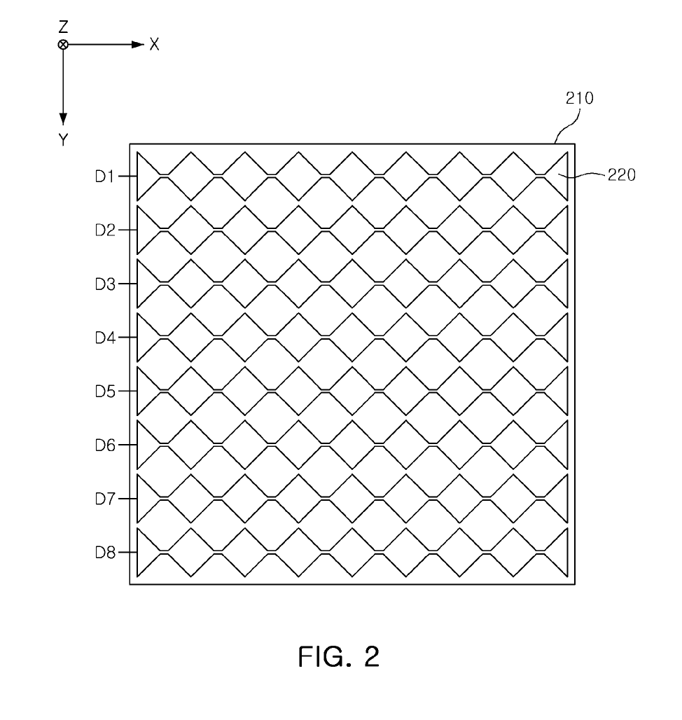

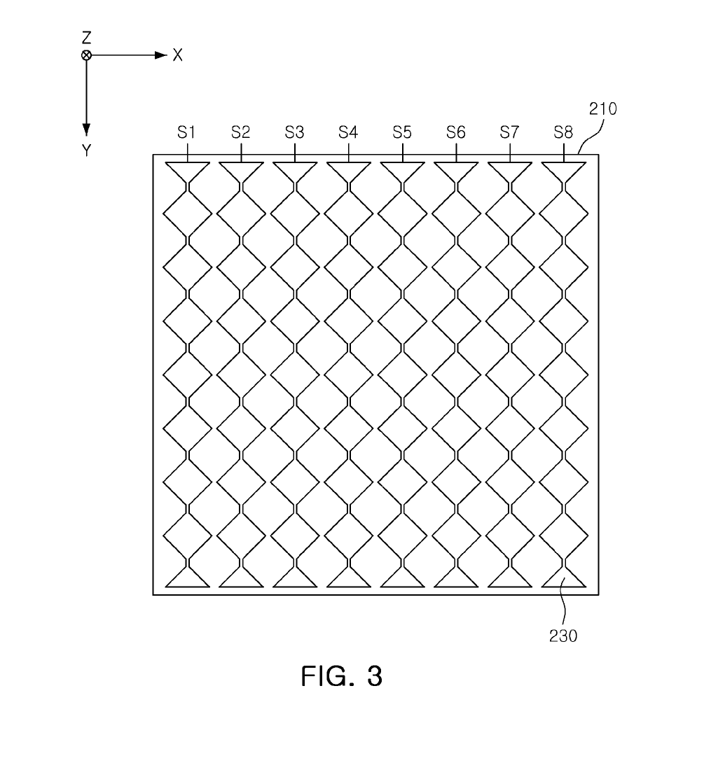

FIGS. 2 and 3 are views schematically illustrating the touch panel according to the embodiment of the present disclosure. Referring to FIGS. 2 and 3, a touch panel 200 according to the present embodiment may include a substrate 210 and a plurality of electrodes 220 and 230 provided on the substrate 210. Although not illustrated in FIG. 2, each of the plurality of electrodes 220 and 230 may be electrically connected to a wiring pattern of a circuit substrate attached to one end of the substrate 210 through wirings and a bonding pad. A controller integrated circuit is mounted on the circuit board to detect a sensing signal generated in the plurality of electrodes 220 and 230 and determine a touch input from the sensing signal.

In a case of the touchscreen apparatus, the substrate 210 may be a transparent substrate for forming the plurality of electrodes 220 and 230. With respect to a region in which the wirings connected to the plurality of electrodes 220 and 230 are provided except for a region in which the plurality of electrodes 220 and 230 are formed, a predetermined printing region may be formed on the substrate 210 in order to visually shield the wirings generally formed of an opaque metal material.

The plurality of electrodes 220 and 230 may be provided on one surface or both surfaces of the substrate 210. Although FIG. 2 shows a case in which the plurality of electrodes 220 and 230 have a rhomboid pattern or a diamond pattern, the plurality electrodes 220 and 230 may be formed in patterns such as a rectangular pattern, a triangular pattern, a circular pattern, and the like, other than the above-mentioned pattern. However, hereinafter, for convenience of explanation, a description will be made based on the case in which the plurality of electrodes 220 and 230 are formed in the rhomboid pattern.

The plurality of electrodes 220 and 230 may include the first electrodes 220 extending in an X-axis direction and the second electrodes 230 extending in a Y-axis direction. The first electrodes 220 and the second electrodes 230 may intersect each other on both surfaces of the substrate 210, or on different substrates 210. In the case in which the first electrodes 220 and the second electrodes 230 are all formed on one surface of the substrate 210, predetermined insulating layers may be partially formed in intersections between the first electrodes 220 and the second electrodes 230.

The controller integrated circuit electrically connected to the plurality of electrodes 220 and 230 to sense a touch input may detect changes in capacitance generated in the plurality of electrodes 220 and 230 according to a touch input applied thereto and sense the touch input therefrom. The first electrode 220 may be connected to channels D1 to D8 in the controller integrated circuit to thereby have a predetermined driving signal applied thereto, and channels S1 to S8 may be used for the controller integrated circuit to detect sensing signals. In this case, the controller integrated circuit may obtain the changes in capacitance generated between the first electrode 220 and the second electrode 230 to thereby use the obtained changes in capacitance as the sensing signals.

In the case in which a contact object is present over or at a region adjacent to a cover lens having the touch input applied thereto, the changes in capacitance may be generated between the first electrode 220 and the second electrode 230. The first electrode 220 and the second electrode 230 are formed of the conductive material, and when the first electrode 220 has a predetermined voltage applied thereto, an electrical field may be generated between the first electrode 220 and the second electrode 230, such that a change in the electrical field by the contact object may cause the changes in capacitance.

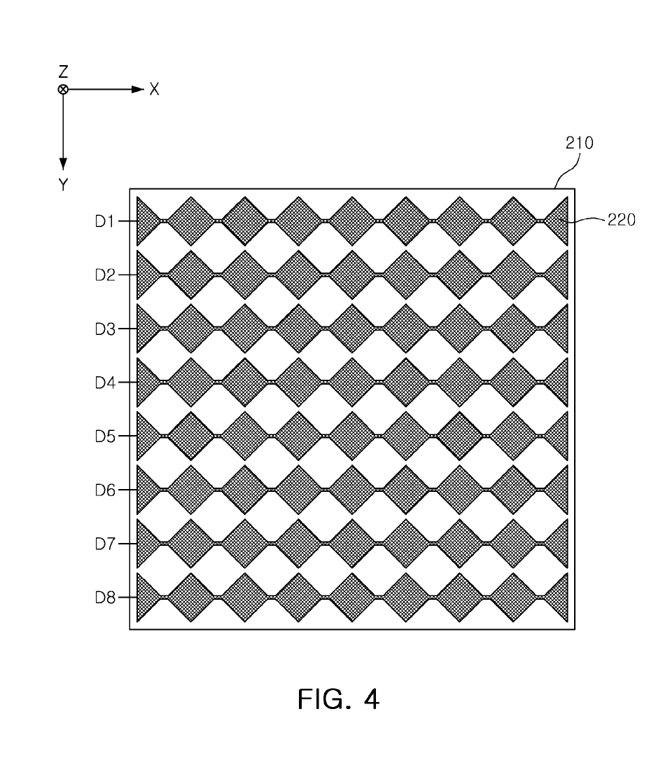

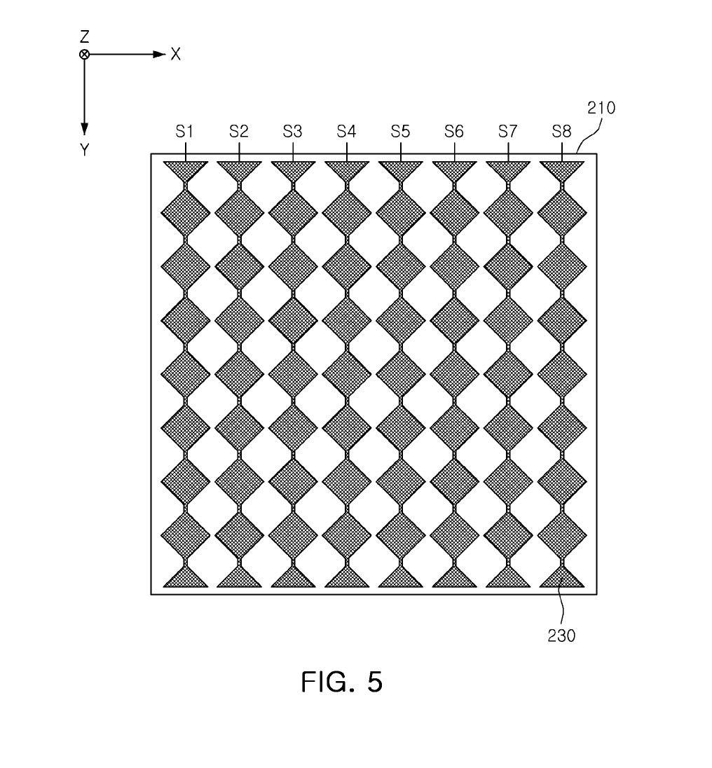

FIGS. 4 and 5 are views illustrating the touch panel according to the embodiment of the present disclosure in greater detail. The plurality of electrodes 220 and 230 may have a plurality of fine conductive lines. The fine conductive lines forming the plurality of electrodes 220 and 230 may be manufactured by using one of silver (Ag), aluminium (Al), chromium (Cr), nickel (Ni), molybdenum (Mo), and copper (Cu), or an alloy thereof. In the case in which the plurality of electrodes 220 and 230 are manufactured of a metal, a resistance value of the electrode may be decreased, such that conductivity and detecting sensitivity thereof may be improved.

The fine conductive lines may be formed in a net or a mesh pattern. In the case in which the fine conductive lines are formed in the net or the mesh pattern, a phenomenon in which a patterning mark is seen in a region in which a pattern electrode conventionally exists may be decreased and transparency of the touch panel may be improved. Although FIGS. 4 and 5 show a case in which the fine conductive lines of the plurality of electrodes 220 and 230 are formed in a rhomboid or rectangular pattern, the pattern of the fine conductive lines is not limited thereto, and the pattern of the fine conductive lines according to the present disclosure may include a range apparently or easily deducted by those skilled in the art such as a hexagon, an octagon, a diamond pattern, a random pattern, and the like.

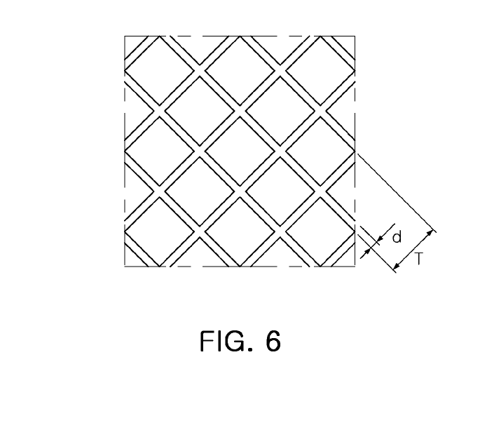

FIG. 6 is a partial enlarged view of fine conductive lines according to the embodiment of the present disclosure. An aperture ratio of the fine conductive lines configuring the plurality of electrodes may be defined by a pitch T and a line width d. As the pitch T is large and the line width d is narrow, the aperture ratio may be increased. Generally, a relationship between the aperture ratio to, and the pitch T and the line width d may be represented by the following Equation 1.

$$to = {( \frac{T - d}{T} )}^{2} \qquad [ Equation 1 ]$$

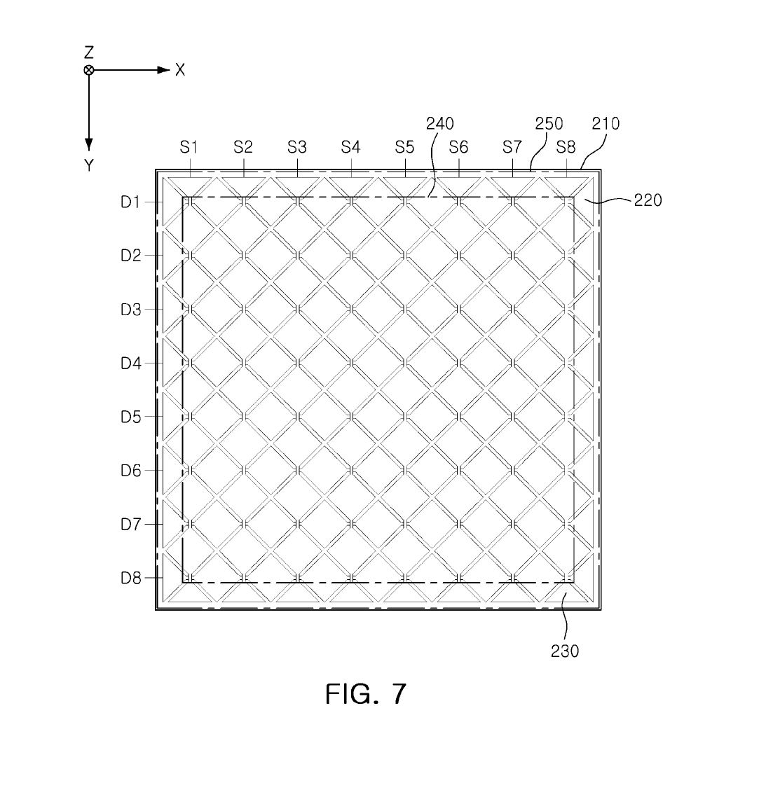

FIG. 7 is a view showing the touch panel according to the embodiment of the present disclosure. In FIG. 7, a central region 240 and an edge region 250 are regions formed by dividing an active region (a region having the touch input applied thereto) of the touch panel, and the fine conductive lines formed in the central region 240 and the edge region 250 may have different aperture ratios.

In the touchscreen apparatus, the central region 240 of the touch panel is a portion to which a display screen is mainly output and the touch is intensively input, and has the aperture ratio set to be relatively greater than that of the edge region 250 in order to have transparency of the touch panel and invisibility of the fine conductive lines greater than those of the edge region 250. In addition, the edge region 250 may have the aperture ratio set to be lower than that of the central region 240 to have decreased resistance and prevent the fine conductive lines from being disconnected due to a step caused by a bezel that may be formed to be adjacent to the edge region 250.

In this case, the aperture ratio of the edge region 250 may be 20% or more to below 100% of the aperture ratio of the central region 240. More specifically, in the case in which the pitch is same in the central region 240 and the edge region 250, the line width of the edge region 250 may be above 100% to below 250% of the line width of the central region 240. Since the line width of the central region 240 may be set to 0.5 μm or more to below 6 μm, the line width of the edge region 250 may be set to 1 μm at a minimum and set to below 10 μm at a maximum.

In a case in which the line width is same in the central region 240 and the edge region 250, the pitch of the edge region 250 may be above 100% to below 500% of the pitch of the central region 240. Since the pitch of the central region 240 may be set to 20 μm or more to below 500 μm, the pitch of the edge region 250 may be set to 40 μm at a minimum and set to below 1000 μm at a maximum.

The aperture ratios may be differently set by simultaneously setting the line width and the pitch to be different.

Meanwhile, areas of the central region 240 and the edge region 250 may be changed by a setting. As an example, the edge region 250 may have the area of 5% or more to below 95% of that of the central region 240.

Although FIG. 7 shows a case in which the active region of the substrate 210 is divided into two regions, that is, the central region 240 and the edge region 250, the present disclosure is not limited thereto. That is, the substrate is divided into a plurality of regions such that the plurality of regions may have predetermined areas in a stepwise manner depending on a distance from a center point of the substrate, and may be set to have the aperture ratios different from each other. In this case, a region having a small distance from the center point may be set to have the aperture ratio greater than that of a region having a distance far from the center point.

In addition, the aperture ratio may also be set to be greater from the edge of the substrate 210 to the center thereof. In this case, the aperture ratio may be changed in a range of 10% or more to below 99%, the line width may be changed in a range of 0.5 μm or more to below 10 μm, and the pitch may be changed in a range of 20 μm or more to below 1000 μm.

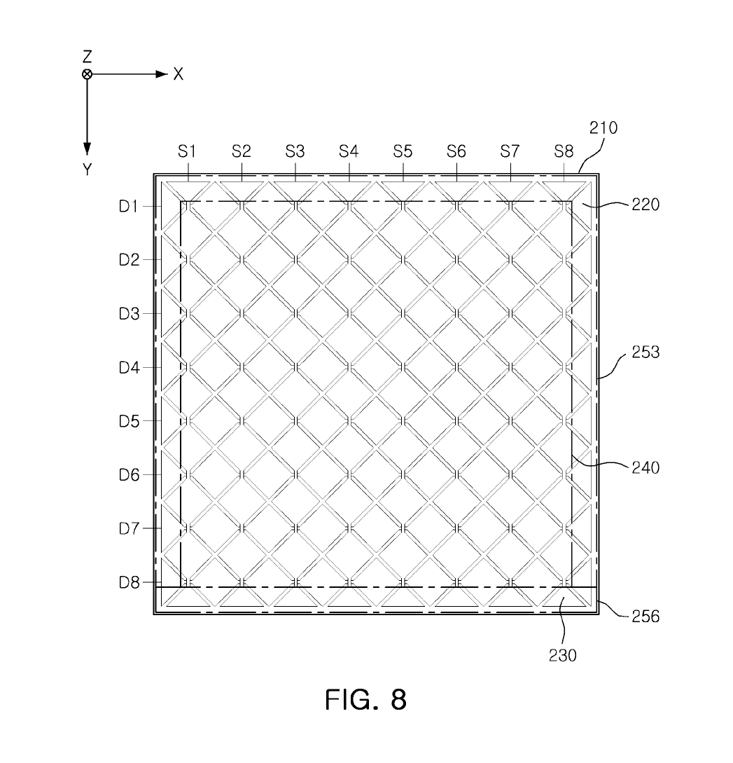

FIG. 8 is a view showing a touch panel according to another embodiment of the present disclosure. In the touch panel according to the embodiment of the present disclosure of FIG. 8, a description for the same portions thereof as those of the touch panel of FIG. 7 will be omitted and portions thereof different from those of the touch panel of FIG. 7 will be mainly described.

Referring to FIG. 8, it may be appreciated that the edge region 250 of FIG. 7 is divided into a first edge region 253 and a second edge region 256. The first edge region 253 may be set to be identical to the edge region 250 of FIG. 7.

The second edge region 256, which is schematically illustrated as a portion relatively distant from the controller integrated circuit detecting the sensing signal from the plurality of electrodes 220 and 230, and it may be appreciated in FIG. 8 that the controller integrated circuit is disposed in a north direction of the substrate 210.

The resistance value of the fine conductive lines forming the plurality of electrodes 220 and 230 may be increased as a distance between the fine conductive lines and the controller integrated circuit is increased. According to the present embodiment, the resistance value may be decreased by setting an aperture ratio of the second edge region 256 to be lower than an aperture ratio of the first edge region 253. More specifically, the line width is set to be thick, the pitch is set to be small, or both of the line width and the pitch are changed, such that the resistance value of the second edge region 256 may be decreased.

While the present disclosure has been shown and described in connection with the embodiments, it will be apparent to those skilled in the art that modifications and variations can be made without departing from the spirit and scope of the disclosure as defined by the appended claims.

What is claimed is:

1. A touch panel, comprising:
a substrate; and
a plurality of electrodes formed on the substrate,
wherein the plurality of electrodes include a plurality of fine conductive lines formed in a mesh pattern, and
the plurality of fine conductive lines have different aperture ratios for a predetermined plurality of respective regions of the substrate.

2. The touch panel of claim 1, wherein the plurality of regions include a central region and an edge region, and
the aperture ratio of the fine conductive lines in the central region is greater than the aperture ratio of the fine conductive lines in the edge region.

3. The touch panel of claim 2, wherein the aperture ratio of the edge region is 20% or more to below 100% of the aperture of the central region.

4. The touch panel of claim 1, wherein the aperture ratios are determined by at least one of a pitch and a line width of the fine conductive lines.

5. The touch panel of claim 2, wherein the fine conductive lines of the edge region have a line width above 100% to 250% or less of a line width of the fine conductive lines of the central region.

6. The touch panel of claim 5, wherein the line width of the fine conductive lines of the central region is 0.5 μm or more to below 6 μm.

7. The touch panel of claim 5, wherein the line width of the fine conductive lines of the edge region is 1 μm or more to below 10 μm.

8. The touch panel of claim 2, wherein the fine conductive lines of the central region have a pitch above 100% to below 500% of a pitch of the fine conductive lines of the edge region.

9. The touch panel of claim 8, wherein the pitch of the fine conductive lines of the central region is 20 μm or more to below 500 μm.

10. The touch panel of claim 8, wherein the pitch of the fine conductive lines of the edge region is 40 μm or more to below 1000 μm.

11. The touch panel of claim 2, wherein the edge region has an area of 5% or more to below 95% of an area of the central region.

12. The touch panel of claim 2, wherein the edge region includes a first edge region and a second edge region, the first edge region being a region having a predetermined area on three sides among four sides of the substrate, the second edge region being a region having a predetermined area on a side among the four sides of the substrate, and the first edge region having an aperture ratio greater than that of the second edge region.

13. The touch panel of claim 12, wherein the second edge region is physically distant from a controller integrated circuit obtaining a sensing signal from the plurality of electrodes, as compared to the first edge region.

14. The touch panel of claim 1, wherein the plurality of fine conductive lines are formed of one of silver (Ag), aluminium (Al), chromium (Cr), nickel (Ni), molybdenum (Mo), and copper (Cu) or an alloy containing at least two of Ag, Al, Cr, Ni, Mo, and Cu.

15. The touch panel of claim 1, wherein the substrate is formed of at least one of polyethylene terephthalate (PET), polycarbonate (PC), polyethersulfone (PES), polyimide (PI), polymethylmethacrylate (PMMA), cyclo-olefin polymers (COP), soda glass, and tempered glass.

16. The touch panel of claim 1, wherein the aperture ratios satisfy the following Equation with respect to a pitch and a line width of the fine conductive lines.
$$to = {( \frac{T - d}{T} )}^{2} \qquad [ Equation ]$$
Where, to is aperture ratio,
T is pitch, and
d is line width.

17. The touch panel of claim 1, wherein the plurality of electrodes include:
a plurality of first electrodes extending in a first axial direction, and
a plurality of second electrodes extending in a second axial direction intersecting with the first axial direction.

18. The touch panel of claim 1, wherein the plurality of first electrodes and the plurality of second electrodes are formed on the same surface or different surfaces of the substrate.

19. A touch panel, comprising:
a substrate; and
a plurality of electrodes formed on the substrate,
wherein the plurality of electrodes include fine conductive lines formed in a mesh pattern, and the fine conductive lines have an aperture ratio increased from an edge of the substrate towards a center thereof.

20. The touch panel of claim 19, wherein the aperture ratio of the fine conductive lines formed in a mesh pattern is changed in a range of 10% or more to below 99%.

21. The touch panel of claim 19, wherein the fine conductive lines have a line width changed in a range of 0.5 μm or more to below 10 μm.

22. The touch panel of claim 19, wherein the fine conductive lines have a pitch changed in a range of 20 μm or more to below 1000 μm.

23. The touch panel of claim 19, wherein the plurality of fine conductive lines are formed of one of Ag, Al, Cr, Ni, Mo, and Cu or an alloy containing at least two of Ag, Al, Cr, Ni, Mo, and Cu.
